(19) United States
(12) Patent Application Publication
(10) Pub. No.: US 2002/0077714 A1
(43) Pub. Date: Jun. 20, 2002

(54) Production management method and system

(75) Inventor: Hiroyuki Takeuchi, Tokyo (JP)

Correspondence Address: McDermott, Will & Emery, 600 13th Street, N.W., Washington, DC, 20005-3096, US

(73) Assignee: MITSUBISHI DENKI KABUSHIKI KAISHA

(21) Appl. No.: 09/826,079

(22) Filed: Apr. 5, 2001

(30) Foreign Application Priority Data
Nov. 16, 2000 (JP) 2000-349026

(51) Int. Cl. G06F 19/00

(52) U.S. Cl. 700/95; 700/100; 700/103

(57) ABSTRACT

The present invention relates to a production management method for predicting time remaining until products are to be produced by way of a plurality of processing processes. Even when manufacturing apparatus are in an unstably operative state or the distribution of objects currently being processed in a plurality of processing processes is nonuniform, a remaining time can be determined accurately. On the basis of data stored in a process flow storage section, all remaining processes through which a predetermined lot is to pass before being produced as products are specified. On the basis of the data stored in an apparatus data storage section, a period of time required for processing in-process objects is determined for each of the remaining processes. All the required periods of time are summed, thereby predicting time remaining until the predetermined lot is produced as products.

### BACKGROUND OF THE INVENTION

1. Field of the Invention

The present invention relates to a method and system for managing production of products, which products are to be manufactured by way of a plurality of processing processes. More particularly, the present invention relates to a method and system for predicting the time remaining until the products are to be completed.

2. Description of the Background Art

The time remaining until objects of processing being produced are to be completed can be determined on the basis of a past performance or the like, so long as manufacturing apparatuses are operating in a stably operative state and the distribution is stable of in-progress objects of processing among a plurality of processing processes.

However, if the manufacturing apparatuses are in an unstably operative state or the distribution of in-process objects among the plurality of processing processes are not uniform, the remaining time cannot be determined accurately on the basis of a past performance.

### SUMMARY OF THE INVENTION

The present invention has been conceived to solve the drawback set forth and is primarily aimed at providing a production management method which enables accurate determination of time remaining until products are to be completed, even when manufacturing apparatuses are in an unstably operative state or the distribution of in-process objects is not uniform among the plurality of processing processes.

The present invention is secondarily aimed at providing a production management system which enables accurate determination of time remaining until products are to be completed, even when manufacturing apparatuses are in an unstably operative state or the distribution of in-process objects is not uniform.

The above-mentioned objects of the present invention are achieved by a production management method for managing production of products to be produced by way of a plurality of processing processes. The method includes a step of specifying all remaining processes through which objects of processing are to pass before being produced as products. The method also includes a step of determining a period of time required for processing in-process objects for each of the remaining processes. The method further includes a step of predicting time remaining until the objects of predetermined processing are to be completed as products, by means of summing all the required periods of time.

The above-mentioned object of the present invention are also achieved by a production management system for managing production of products to be manufactured by way of a plurality of processing processes. The system includes a remaining-process specifying section for specifying all remaining processes through which objects of processing are to pass before being produced as products. The system also includes a required-period-of-time computing section for determining a period of time required for processing in-process objects for each of the remaining processes. The system further includes a remaining-period-of-time computing section for determining time remaining until the objects of processing are to be completed as products, by means of summing all the required periods of time.

Other objects and further features of the present invention will be apparent from the following detailed description when read in conjunction with the accompanying drawings.

### BRIEF DESCRIPTION OF THE DRAWINGS

FIG. 1 is a block diagram showing the overall configuration of a production management system according to a first embodiment of the present invention;

FIG. 2 shows an example of process flow data employed in the first embodiment of the present invention;

FIG. 3 shows an example of apparatus data employed in the first embodiment of the present invention;

FIG. 4 shows an example of in-process data employed in the first embodiment of the present invention;

FIG. 5 shows an example of progress data employed in the first embodiment of the present invention; and

FIG. 6 shows an example of Predicted days for progress computed by the production management system according to the first embodiment of the present invention.

### DESCRIPTION OF THE PREFERRED EMBODIMENTS

A preferred embodiment of the present invention will now be described by reference to the accompanying drawings. Throughout the drawings, like elements are assigned like reference numerals, and repetition of their explanations is omitted.

Embodiment 1

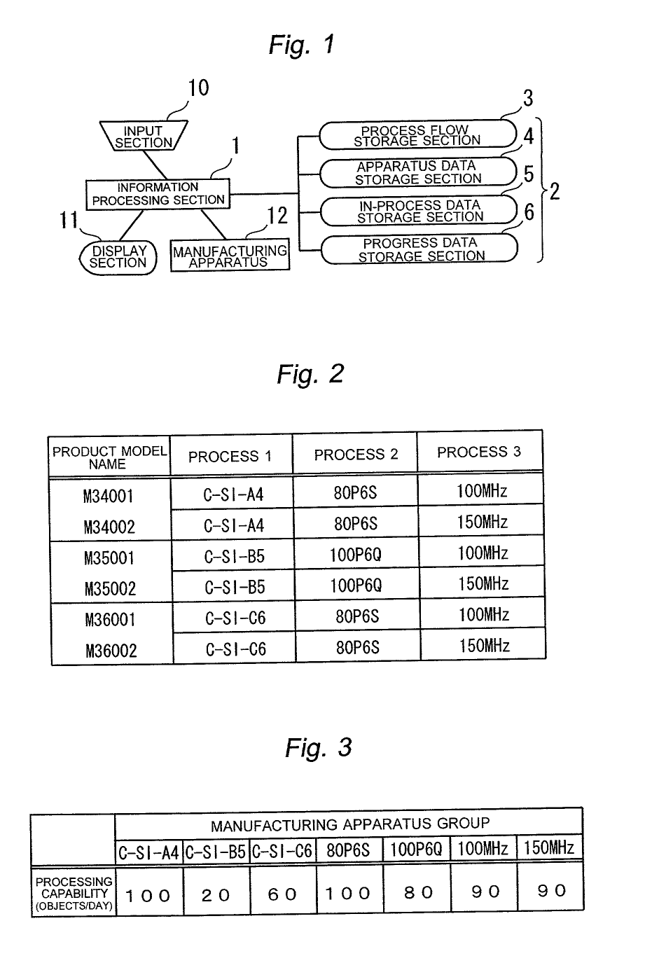

FIG. 1 is a block diagram showing the overall configuration of a production management system according to a first embodiment of the present invention. The production management system according to the present embodiment comprises a computer for production management purpose and a plurality of manufacturing apparatuses 12 for subjecting objects to predetermined processing on a production line.

In FIG. 1, reference numeral 1 designates an information processing section for computing time remaining until products are to be completed. The information processing section 1 is connected to a storage section 2 for storing the information required for production management. The storage section 2 is equipped with four data files; more specifically, a process flow storage section 3, an apparatus data storage section 4, an in-process data storage section 5, and a progress data storage section 6.

Reference numeral 10 shown in FIG. 1 designates an input section to be used for registering or changing the data required for production management. More specifically, date to be stored in the storage section 2 such as process flow data, apparatus data or in-progress data of objects in individual processes are entered by way of the input section 10. The data may be manually entered by an operator or automatically entered by means of utilization of a factory automation function by way of the input section 10.

As shown in FIG. 1, reference numeral 11 designates a display section, and 12 designates a manufacturing apparatus. Various types of data sets stored in the storage section 2 and the processing results of the information processing section 1 such as a remaining period are displayed on the display section 11. The manufacturing apparatus 12 is disposed on a production line for subjecting objects to predetermined processing. Although FIG. 1 shows only one manufacturing apparatus 12, in reality a plurality of manufacturing apparatuses 12 are connected to the information processing section 1.

FIG. 2 shows contents of the process flow data stored in the process flow storage section 3. As shown in FIG. 2, the process flow storage section 3 stores, for each product model name, the types of processes to be performed and a sequence in which the processes are to be performed. More specifically, the process flow data shown in FIG. 2 show that products for each model name are completed by means of being subjected to processing in the sequence given from Process 1, Process 2, and Process 3. In the present embodiment, three processes are prepared for each product, regardless of model name. However, there is no necessity that respective products be subjected to the same number of processes; processes to be performed for each product model name may differ in number from each other.

Further, a group of manufacturing apparatuses to be used for respective processes is also included in the process flow data. For instance, with regard to products of model name M34001, it is stored in the process flow data that procedures by a group of manufacturing apparatuses C-SI-A4 are performed in Process 1, procedures by a group of manufacturing apparatuses 80P6S are performed in Process 2, and procedures by a group of manufacturing apparatuses 100 MHz are performed in Process 3. The process flow data are registered in the process flow storage section 3 by way of the input section 10 before production of products is commenced.

FIG. 3 shows contents of the apparatus data to be stored in the apparatus data storage section 4 shown in FIG. 1. As shown in FIG. 3, processing capability of each manufacturing apparatus group is stored in the apparatus data storage section 4. For instance, the fact that the group of manufacturing apparatus C-SI-A4 is capable of processing 100 objects in one day is stored. The apparatus data are registered in the apparatus data storage section 4 before production of products is commenced.

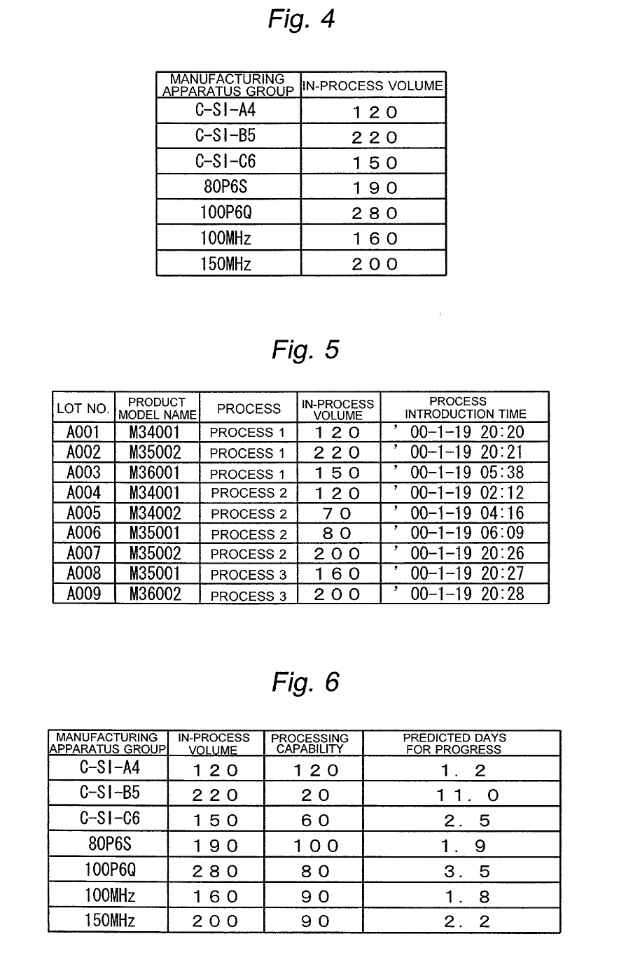

FIG. 4 shows contents of the in-process data to be stored in the in-process data storage section 5 shown in FIG. 1. As shown in FIG. 4, the in-process data storage section 5 stores the number of objects being processed by each of the manufacturing apparatus groups stored in the process flow data storage section 3; that is, the volume of objects currently being processed in an individual manufacturing apparatus group. For instance, the in-process data shown in FIG. 4 represent that the manufacturing apparatus group C-SI-A4 is currently processing 120 objects. The volume of objects currently being processed by each of the manufacturing apparatus groups is updated in an incrementing manner every time new objects of processing are introduced, by means of manual or automatic operation. Further, the volume of objects currently being processing is updated such that the number of objects which have been processed decreases.

FIG. 5 shows contents of progress data to be stored in the progress data storage section 6 shown in FIG. 1. In the present embodiment, objects of processing are processed on a per-lot basis. A lot number is assigned to an individual lot before the lot is introduced to a first processing process (i.e., Process 1). As shown in FIG. 5, progress data are sorted in accordance with lot numbers. Each of the progress data sets comprises the product model name of an individual lot, a process in which the lot is currently being processed, the volume of the lot currently being processed, and the time at which the lot was introduced to the process.

For example, of the progress data sets shown in FIG. 5, data pertaining to Lot No. 1 relate to a lot of product model name M34001, and the lot is currently being processed in Process 1. The lot contains 120 objects of processing, and the lot was introduced into Process 1 at 20:20 on Jan. 19, 2000. The progress data are updated on a per-row basis (i.e., on a per-lot-number basis), whenever a new lot is introduced to the production management system according to the present embodiment or when the processed lot is removed from the production management system according to the present embodiment. Every time an individual lot is introduced to a new process, the in-process process data and the process-introduction-time data pertaining to the lot among the progress data pertaining thereto are updated.

Next will be described a technique by which the production management system according to the present embodiment predicts time remaining until certain objects being processed are to be completed as products, on the basis of the various types of data sets.

The process flow data shown in FIG. 2, the apparatus data shown in FIG. 3, the in-process data shown in FIG. 4, and the progress data shown in FIG. 5 are supplied to the information processing section 1. The information processing section 1 computes a period of time required for each processing apparatus group to process in-process objects by means of the following algebraic logic and by reference to the apparatus data (shown in FIG. 3) and the in-process data (shown in FIG. 4) of the above-described data sets. The time computed will be called “predicted days for progress” hereunder.

Predicted days for progress=the in-process volume of a manufacturing apparatus group/processing capability of the manufacturing apparatus group.

According to the apparatus data shown in FIG. 3 and the in-process data shown in FIG. 4, an individual manufacturing apparatus group assumes predicted days for progress such as those shown in FIG. 6. The thus-determined predicted days for progress correspond to a period of time required for an individual manufacturing apparatus group to process objects being currently processed. The period of time can be expected to be less susceptible to great changes unless large variations arise in current production loads or anomalies arise in the manufacturing apparatuses. More specifically, the predicted days for progress pertaining to an individual manufacturing apparatus group shown in FIG. 6 can be expected to be less variable in a short period of time, without regard to whether an individual manufacturing apparatus is stably operative or unstably operative or whether the distribution of in-process objects is uniform or not.

By means of utilization of the computed predicted days for progress shown in FIG. 6, the production management system according to the present embodiment computes, for each lot number, time remaining until products are to be completed. Procedures according to which the information processing section 1 computes time remaining pertaining to a lot number A001 will now be described.

On the basis of the progress data shown in FIG. 5, the information processing section 1 detects that lot number A001 corresponds to a lot of products of model name M34001 and that the lot is currently being processed in Process 1.

By reference to the process flow data shown in FIG. 2, the information processing section 1 detects that products of model name M34001 are to be manufactured by way of Processes 1 through 3 and that a manufacturing apparatus group C-SI-A4 is to be used for processing products of M34001 in Process 1. Further, the information processing section 1 detects that a manufacturing apparatus group 80P6S is to be used in Process 2 and that a manufacturing apparatus group 100 MHz is to be used in Process 3.

On the basis of the above-described detection results, the information processing section 1 perceives that lot number A001 must be subjected to processing in Processes 1 through 3 before products are finally produced and that the manufacturing apparatus groups mentioned above must be used in respective Processes 1 through 3.

On the basis of the apparatus data shown in FIG. 3 and the in-process data shown in FIG. 4, the information processing section 1 computes predicted days for progress required for processing lot No. A001. More specifically, the information processing section 1 computes the predicted days for progress required by the manufacturing apparatus group C-SI-A4 used in Process 1, the predicted days for progress required by the manufacturing apparatus group 80P6S used in Process 2, and the predicted days for progress required by the manufacturing apparatus group 100 MHz used in Process 3. In the present embodiment, the predicted days for progress required by the manufacturing apparatus group C-SI-A4 assume 1.2 days; the predicted days for progress required by the manufacturing apparatus group 80P6S assume 1.9 days; and the predicted days for progress required by the manufacturing apparatus group 100 MHz assume 1.8 days.

It is expected that the thus-computed predicted days for progress of 1.2 days, 1.9 days, and 1.8 days will not change greatly within a short period of time, without regard to the operative state of an individual manufacturing apparatus and the distribution of in-process objects of processing. Accordingly, it can be ascertained that the predicted days for progress of 1.2 days, 1.9 days, and 1.8 days are periods of time required for lot No. A001 to pass through Processes 1, 2, and 3. The information processing section 1 predicts a total sum of these predicted days for progress 1.2, 1.9, and 1.8 days; that is, 4.9 days, as time remaining until lot No. A001 is to be completed as products. The information processing section 1 predicts days for progress for all lots to be processed by the system according to the present embodiment, in accordance with the procedures mentioned above.

In the present embodiment, included in the progress data shown in FIG. 5 is the latest process introduction time at which an individual lot has been introduced into an individual process. The information processing section 1 adds the remaining time which has been computed in accordance with the foregoing procedures to the latest process introduction time so as to determines a predicted time at which the individual lot is to be completed. The thus-determined predicted time is displayed on the display section 11. In connection with lot No. A001, '00-1-24 is displayed as an expected completion day.

The display section 11 may display an expected completion hour as well as an expected day serving as an expected completion time. In the present embodiment, the processing capability of a processing apparatus group and a prediction of progress in a process are displayed in terms of days. However, the unit for display is not limited to a day; the data be displayed in terms of hours, weeks, or months.

Since the present invention has been embodied in the manner as mentioned above, the following advantages are yielded.

The present invention can determine a required period of time corresponding to the current production capability, for all processes through which objects of processing are to pass later. By means of addition of the thus-determined required periods of time, time remaining until products are to be completed can be computed accurately without regard to the operative state of manufacturing apparatus or the distribution of in-process objects.

According to the present invention, a product model name and in-process processes are recorded for each lot. The record is checked against preliminarily-stored process flow data, thus readily and accurately specifying remaining processes for an individual lot.

On the basis of the processing capability of an individual manufacturing apparatus group and the volume of objects which are being processed in an individual manufacturing apparatus group, the present invention can readily and accurately compute the period of time required for an individual process under the current production load.

According to the present invention, an expected time at which products are to be completed under the current production load can be displayed for each type of product.

Further, the present invention is not limited to these embodiments, but variations and modifications may be made without departing from the scope of the present invention.

The entire disclosure of Japanese Patent Application No. 2000-349026 filed on Nov. 16, 2000 including specification, claims, drawings and summary are incorporated herein by reference in its entirety.

What is claimed is:

1. A production management method for managing production of products to be produced by way of a plurality of processing processes, the method comprising the steps of:
specifying all remaining processes through which objects of processing are to pass before being produced as products;
determining a period of time required for processing in-process objects for each of the remaining processes; and
predicting time remaining until the objects of predetermined processing are to be completed as products, by means of summing all the required periods of time.

2. The production management method according to claim 1, wherein:
the objects of processing are processed on a per-lot basis;
said method further comprises the steps of recording a product model name of an individual lot; and recording, for an individual lot, a process in which a lot is being processed; and
the step of specifying the remaining processes comprises a sub-step of specifying process flow data corresponding to a lot including the objects of processing on the basis of the product model name of the lot and process flow data set beforehand for each product model name, and a sub-step of specifying remaining processes through which the lot is to be passed, on the basis of the process in which the lot is being processed and the specified process flow data.

3. The production management method according to claim 2, wherein:
the process flow data include data pertaining to the type of processes to be performed, a sequence in which the processes are to be performed, and a group of manufacturing apparatus used in an individual process; and
the required period of time is computed, on the basis of the processing capability of the manufacturing apparatus group used in each of the remaining processes and the volume of in-process objects which are currently being processed by an individual manufacturing apparatus group.

4. The production management method according to claim 1, further comprising the steps of:
recording a time at which the object of processing is to be introduced to the latest process;
determining a time at which products are to be completed, by means of adding the remaining time to the recorded time; and
displaying on the display section the time at which products are to be completed.

5. A production management system for managing production of products to be manufactured by way of a plurality of processing processes, the system comprising:
a remaining-process specifying section for specifying all remaining processes through which objects of processing are to pass before being produced as products;
a required-period-of-time computing section for determining a period of time required for processing in-process objects for each of the remaining processes; and
a remaining-period-of-time computing section for determining time remaining until the objects of processing are to be completed as products, by means of summing all the required periods of time.

6. The production management system according to claim 5, wherein:
the objects of processing are processed on a per-lot basis;
the system further comprises a first progress data storage section for recording a product model name of an individual lot, a second progress data storage section for recording, for an individual lot, a process in which a lot is being processed, and a process flow data storage section storing process flow data which have been set beforehand for each product model name; and
the remaining-process specifying section further comprises a first specifying section for specifying process flow data corresponding to a lot including the objects of processing, on the basis of data stored in the first progress data storage section and data stored in the process flow data storage section, and a second specifying section for specifying remaining processes corresponding to the lot, on the basis of the data stored in the second progress data storage section and the specified process flow data.

7. The production management system according to claim 6, wherein:
the process flow data storage section stores data pertaining to the type of processes to be performed, to a sequence in which the processes are to be performed, and to a group of manufacturing apparatus used in an individual process;
the system further comprises an apparatus data storage section for storing the processing capability of an individual manufacturing apparatus group, and an in-process data storage section for storing the volume of objects of processing currently being processed by an individual manufacturing apparatus group; and
the required-period-of-time computing section computes the required period of time, on the basis of the processing capability of a manufacturing apparatus group used in each of the remaining processes and the volume of objects of processing currently being processed by an individual manufacturing apparatus group.

8. The production management system according to claim 5, further comprising:
a third progress data storage section for recording a time at which the object of processing is to be introduced to the latest process;
a predicted-completion-time computing section for determining a time at which products are to be completed, by means of adding the remaining time to the time recorded; and
a display processing section for displaying on the display section the time at which products are to be completed.
